(19) United States
(12) Patent Application Publication
(10) Pub. No.: US 2019/0217818 A1
(43) Pub. Date: Jul. 18, 2019

(54) SMART DOOR LOCK AND METHOD FOR CONTROLLING SAME

(71) Applicant: SHENZHEN ROYOLE TECHNOLOGIES CO. LTD., Shenzhen, Guangdong (CN)

(72) Inventors: Jianhai YE, Shenzhen, Guangdong (CN); Hui YANG, Shenzhen, Guangdong (CN); Heli LIU, Shenzhen, Guangdong (CN)

(21) Appl. No.: 16/334,277

(22) PCT Filed: Sep. 21, 2016
(86) PCT No.: PCT/CN2016/099581

§ 371 Date: Mar. 18, 2019

(51) Int. Cl. B60R 25/25; G07C 9/00

(52) U.S. Cl. CPC B60R 25/252; G07C 9/00087; G07C 9/00158; B60R 2325/40; G07C 2009/00095; B60R 2325/103; B60R 2325/205; G07C 9/00563

(57) ABSTRACT

A smart door lock includes a fingerprint identification module and a controller. The fingerprint identification module is electrically connected with the controller. The fingerprint identification module is used to send collected fingerprint information to the controller. The controller is used to determine, according to the fingerprint information, whether to perform unlocking operation. The smart door lock is capable of meeting application requirements in different scenarios.

### RELATED APPLICATION

The present application is a National Phase of International Application Number PCT/CN2016/099581, filed Sep. 21, 2016.

### TECHNICAL FIELD

The present disclosure relates to a field of smart electrical apparatus, and more particularly, to a smart door lock and a method for controlling a smart door lock.

### BACKGROUND

Nowadays, with the ever-growing development of science and technology, smart electrical apparatus (such as smart air conditioners, smart washing machines, smart sweepers, smart rice cookers, smart automobiles or the like) have been playing an important role in all aspects of life; furthermore, intellectualization has become a trend for science and technology products.

For now, door locks (such as car locks, house locks, safe locks or the like) require users to carry keys or remember passwords to unlock, but in some scenarios, this cannot meet users' needs, such as when users forget to carry keys or forget passwords.

### SUMMARY

Implementations of the present disclosure provide a smart door lock and a method for controlling a smart door lock, which can meet application requirements of different scenarios.

In a first aspect, a smart door lock is provided in prevent disclosure, including: a fingerprint identification module and a controller; wherein the fingerprint identification module is electrically connected to the controller, the fingerprint identification module is configured to transmit collected fingerprint information to the controller, and the controller is configured to determine whether to perform an unlocking operation according to the fingerprint information.

In a second aspect, a method for controlling a smart door lock applicant on the smart door lock as shown in the first aspect, is provided in the prevent disclosure, including: collecting fingerprint information by a fingerprint identification module of the smart door lock; and determining, by a controller of the smart door lock, whether to perform an unlocking operation according to the fingerprint information.

The smart door lock provided in the present disclosure, includes a fingerprint identification module and a controller. The fingerprint identification module transmits collected fingerprint information to the controller, and then the controller determines whether to perform an unlocking operation according to the fingerprint information. Thus the smart door lock can meet application requirements of different scenarios, especially when users forget to carry keys or forget passwords.

### BRIEF DESCRIPTION OF THE DRAWINGS

In order to more clearly explain technical solutions in the embodiments of the present disclosure or the prior art, drawings that need to be used in the embodiments or the prior art will be briefly introduced below. Obviously, the drawings in the following description are only some embodiments of the present disclosure. For those ordinarily skilled in the field, other drawings can be obtained without paying creative work.

FIG. 1 is a schematic view of structure of a smart door lock according to an implementation of the present disclosure;

FIG. 2 is a schematic view of structure of a smart door lock according to an implementation of the present disclosure, where a flexible touch screen of the smart door lock is positioned on a widow of an automobile;

FIG. 3 is a flowchart of a method for controlling the smart door lock according to an implementation of the present disclosure;

FIG. 4 is a schematic display interface of a flexible touch screen of the smart door lock according to an implementation of the present disclosure;

FIG. 5 is a flowchart of a method for controlling the smart door lock according to another implementation of the present disclosure.

### DETAILED DESCRIPTION

In order to make purpose, technical solution and advantages of the embodiments of the present disclosure more clear, the following is a clear and complete description of the technical solution of the embodiments of the present disclosure, with reference to the drawings of the embodiments of the present disclosure. Obviously, the described embodiments are only some but not exclusive embodiments of the present disclosure. Based on the embodiments of the present disclosure, all other embodiments obtained by those ordinarily skilled in the field without creative work should fall within the scope of protection of the present disclosure.

Unless otherwise indicated, technical or scientific terms used herein shall be interpreted as generally acknowledged by those ordinarily skilled in the field to which the present disclosure belongs. Terms of “first”, “second”, “third” and “fourth” and the like used in the present disclosure are used to distinguish different objects instead of sequencing a specific order, quantity or importance. Similarly, terms such as “a”, “one” or “the” do not intend to limit quantity, but merely to state the presence of at least one. Similar terms such as “including” or “comprising” mean that the elements or articles appearing before the terms cover the elements or articles and their equivalents listed after the word, and do not exclude other elements or articles. Similar terms such as “connected” or “communicated” are not limited to direct physical or mechanical connection, but also include direct or indirect electrical connection. Terms such as “up”, “down”, “left” and “right” are only intended to indicate relative position. When an absolute position of a described object changes, the relative position may also change accordingly.

Embodiment herein refers to that particular features, structures, or characteristics described therein may be included in at least one embodiment of the present disclosure. The word cited in different sections of the specification does not necessarily refer to be understood as in the same embodiment, nor refer to an independent or alternative embodiment mutually exclusive with other embodiments. Those skilled in the field understand explicitly and implicitly that the embodiments described herein may be combined with other embodiments.

To help those skilled in the field better understand the present disclosure, some terms will be explained below.

1) A user equipment (UE) is a device that provides voice and/or data connectivity to users, such as a handheld device, a vehicle-mounted device or the like with a wireless connection function. Common user equipments include, for example, mobile phones, tablet computers, notebook computers, handheld computers, mobile internet devices (MID), wearable devices such as smart watches, smart bracelets, pedometers or the like.

2) A fingerprint identification module is configured to identify individual fingerprint features through a specific induction module. For now, the fingerprint identification module mainly includes an optical fingerprint identification module, a capacitive fingerprint identification module and a radio frequency fingerprint identification module. The physical structure of the fingerprint identification module may be a fingerprint chip in chip package.

3) Fingerprint information refers to image data of a person's fingerprints stored in a certain way so as to be browsed, consulted or compared and analyzed when necessary. Fingerprint information includes fingerprint features, which represent fingerprint feature points of fingerprint images. Fingerprint features include overall features and local features, where overall features include basic grain patterns of loop, arch and whorl. Local features refer to minutia points of fingerprints. Two fingerprints may generally have an identical overall characteristic, but their local characteristics—minutia points—cannot be exactly the same. Fingerprint lines of minutia points are not continuous, smooth or straight, but generally break, bifurcated and curved. These breakpoints, bifurcation points and turning points are called “minutia points”. These minutia points provide unique verification information for fingerprint. Minutia points on fingerprints have five different characteristics: 1. endings, where each fingerprint line ends; 2. bifurcations, where each fingerprint line is bifurcated into two or more lines; 3. ridge divergences, where two parallel fingerprint lines are diverged; 4. dots or islands, which are very short fingerprint lines, which may also be deemed as dots; 5. enclosures: where each fingerprint line is bifurcated for a short distance and then merged into one, forming a small ring called enclosure. Fingerprint features data may also include: short ridges: which are short fingerprint lines but not short enough to be a dot; orientations: where minutia points are directed; curvatures—which describes a direction changing rate of fingerprint lines; positions: which may be described by (x,y) coordinates, and may be absolute identification or inductive identification relative to triangular points or feature points.

4) Matching means that some or all features of compared objects are the same. For example, if some features of fingerprint information are the same as those of a pre-stored fingerprint template, or if all features of fingerprint information are the same as those of the pre-stored fingerprint template, then the fingerprint information is matched with the pre-stored fingerprint template, otherwise, it is not matched.

5) “Multiple” refers to two or more than two. “And/or” describes an association relationship of associated objects, indicating that there can be three kinds of relationships, for example, A and/or B, which can indicate that there are three cases of A, A and B, and B alone. The character “/” generally indicates that the context object is an “or” relationship.

Embodiments of the present application will be described below with reference to the accompanying drawings.

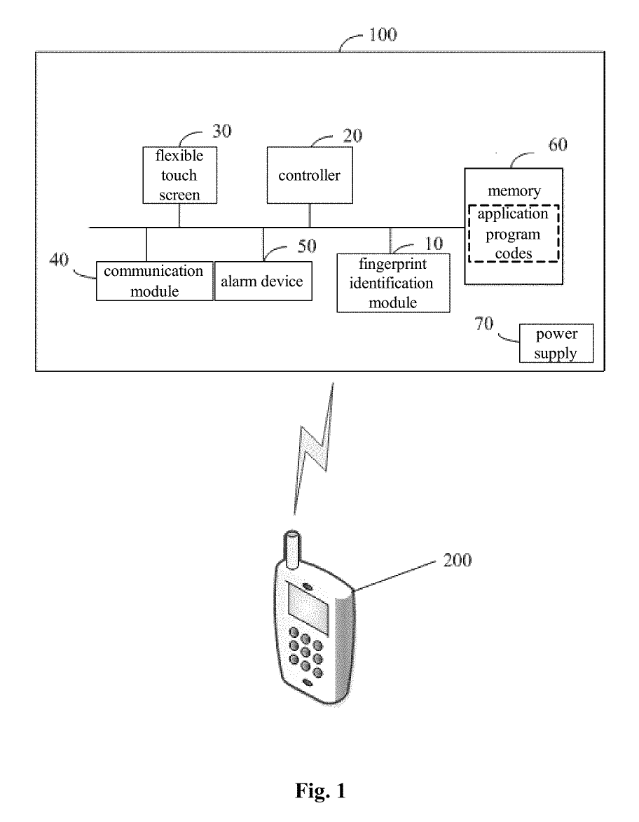

Referring to FIG. 1, which is a schematic view of structure of a smart door lock 100 according to an implementation of the present disclosure. The smart door lock 100 includes a fingerprint identification module 10 and a controller 20, where the fingerprint identification module 10 is electrically connect to the controller 20, the fingerprint identification module 10 is configured to transmit collected fingerprint information to the controller 20, and the controller 20 is configured to determine whether to perform an unlocking operation according to the fingerprint information. The smart door lock of the disclosure can meet the application requirements of various occasions, especially when users forget to carry keys or forget passwords.

The controller 20 may be a general central processing unit (CPU), a microprocessor, an application-specific integrated circuit (ASIC), or one or more integrated circuits for controlling program execution of the above scheme.

In one embodiment, the fingerprint identification module 10 is configured to collect a first fingerprint information and a second fingerprint information, and the controller 20 is configured to perform the unlocking operation when the first fingerprint information and the second fingerprint information are correct.

In one embodiment, the second fingerprint information includes information concerning a plurality of fingerprints input sequentially.

In one embodiment, the second fingerprint information includes fingerprint information input for a first time and fingerprint information input for a second time, and the fingerprint information input for the second time is different from the fingerprint information input for the first time.

In one embodiment, the number of fingerprints in the fingerprint information input for the second time is different from the number of fingerprints in the fingerprint information input for the first time.

In one embodiment, the fingerprints in the fingerprint information input for the second time are not repeated with the fingerprints in the fingerprint information input for the first time.

In one embodiment, the second fingerprint information is collected later than the first fingerprint information.

In one embodiment, the fingerprint identification module 10 includes a flexible touch screen 30, where the fingerprint identification module 10 and the flexible touch screen 30 are laminated, and the flexible touch screen 30 is positioned on outer surface of the smart door lock, that is, the fingerprint identification module 10 is in contact with inner surface of the flexible touch screen 30. The flexible touch screen 30 is electrically connect to the controller 20 to display corresponding contents in response to a control of the controller 20 and to transmit touch information to the controller 20 in response to a touch operation. It can be understood that, when accuracy of sensing circuits of the flexible touch screen 30 is high enough, the flexible touch screen 30 can identify fingerprints by itself. Therefore, the fingerprint identification module 10 may also be the flexible touch screen 30.

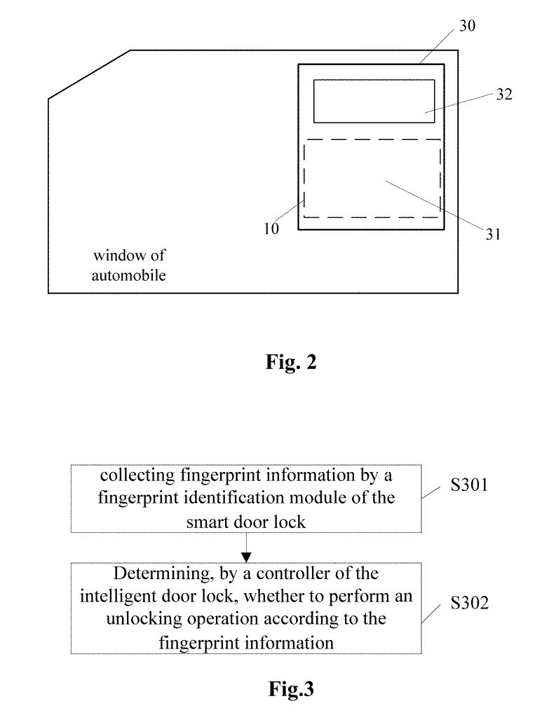

As shown in FIG. 2, in one embodiment, the smart door lock 100 is a door lock of an automobile, and the flexible touch screen 30 is adhered on a window of the automobile. Obviously, in other embodiments, the smart door lock can be a door lock of a house, and the flexible touch screen 30 is adhered on a surface of a door of the house. The smart door lock can also be a door lock of a cabinet, and the flexible touch screen 30 is adhered on a surface of a door of the cabinet.

In one embodiment, as shown in FIG. 2, the flexible touch screen 30 includes a touch area 31, and the fingerprint identification module 10 is disposed below the touch area 31, that is, the fingerprint identification module 10 is in contact with inner surface of the touch area 31. In this embodiment, the flexible touch screen 30 is transparent, so the fingerprint identification module 10 located below the flexible touch screen 30 can receive a user's fingerprint through the flexible touch screen 30, then the flexible touch screen 30 can collect the fingerprint information. When the fingerprint identification module 10 is the flexible touch screen 30, the fingerprint information of a user can be collected by the flexible touch screen 30. In addition to have a touch recognition function, the flexible touch screen 30 may also be integrated with a display module (such as an OLED screen) to display desired contents.

In one embodiment, as shown in FIG. 2, the flexible touch screen 30 further includes a display area 32, and the controller 20 is configured to control the display area 32 to display prompt information for prompting users to input fingerprint information.

In one embodiment, the prompt information includes at least one of numbers, images and texts.

In one embodiment, the smart door lock further includes a communication module 40, where the communication module 40 is configured to communicate with other devices through a wired or wireless communication network, and the communication network may be an Ethernet, a radio access network (RAN), a Wireless Local Area Networks (WLAN), a GPRS network, a CDMA network, a LTE network or the like.

The controller 20 is configured to send fingerprint verification failure information to a preset terminal device 200 through the communication module 40 when the first fingerprint information or the second fingerprint information are wrong more than a preset amount of times, and the communication module 40 is electrically connect to the controller 20.

In one embodiment, the smart door lock 100 includes an alarm device 50 electrically connected to the controller 20, and the controller 20 is configured to control the alarm device 50 to raise an alarm when the first fingerprint information or the second fingerprint information are wrong more than the preset amount of times. Specifically, the communication module 40 is further configured to receive alarm information sent by the terminal device 200, and the controller 20 is configured to control the alarm device 50 to raise the alarm when the communication module 40 receives the alarm information sent by the terminal device 200. The alarm device may be a sound alarm device or a visual alarm device or a combination of the two, for example, the alarm device may be a loudspeaker, a breathing light, or may include both a loudspeaker and a breathing light or the like.

In one embodiment, the smart door lock further includes a power supply 70, where the fingerprint identification module 10, the controller 20, the flexible touch screen 30, the communication module 40 and the alarm device 50 are all connect to the power supply and receive working voltage from the power supply.

In one embodiment, the smart door lock further includes a memory 60, which may be a read-only memory (ROM), or other type of static storage device that can store static information and instructions, a random access memory (RAM), or other type of dynamic storage device that can store information and instructions. The memory may also be an Electrically Erasable Programmable Read-Only Memory (EEPROM), a Compact Disc Read-Only Memory, CD-ROM) or other CD Memories, CD-ROM Memories (including compact disks, laser disks, optical disks, digital versatile disks, Blue-ray disks or the like), magnetic disk storage medias or other magnetic storage devices, or any other medias capable of carrying or storing desired program code in a form of instructions or data structures and capable of being accessed by a computer, but is not limited thereto. The memory 60 may exist independently and be connected to the controller 20 via a bus. The memory 60 may also be integrated with the controller 20.

Where, the memory 60 is configured to store application program codes for executing a method for controlling a smart door lock provided below, and which is controlled and executed by the controller 20. The controller 20 is configured to execute the application program codes stored in the memory 60, thereby executing the method for controlling the smart door lock described below.

FIG. 3 is a flowchart of a control method including a specific execution process of the smart door lock described above. Although the smart door lock described herein is implemented based on the smart door lock 100 shown in FIGS. 1-2, it should be noted that the specific operating environment of the method for controlling the smart door lock disclosed in the embodiment of the present disclosure is not limited to the above-mentioned smart door lock 100.

As shown in FIG. 3, the method for controlling the smart door lock disclosed in a method embodiment of the present disclosure specifically includes actions at the following blocks:

At block 301, the fingerprint identification module 10 of the smart door lock 100 collects fingerprint information.

At block 302, the controller 20 of the smart door lock 100 determines whether to perform an unlocking operation according to the fingerprint information.

In one embodiment, the fingerprint identification module 10 of the smart door lock 100 collecting the fingerprint information specifically is: the fingerprint identification module 10 of the smart door lock 100 collects a first fingerprint information.

In one embodiment, after the fingerprint identification module 10 of the smart door lock 100 collecting the first fingerprint information, the controller 20 of the smart door lock 100 determines whether the first fingerprint information is correct.

In one embodiment, when the controller 20 of the smart door lock 100 determines that the first fingerprint information is correct, the fingerprint identification module 10 of the smart door lock 100 collects a second fingerprint information.

In one embodiment, the second fingerprint information includes fingerprint information which input for many times.

In one embodiment, the controller 20 of the smart door lock 100 determines whether to perform the unlocking operation according to the fingerprint information input each time and an input sequence of the fingerprint information.

In one embodiment, before the fingerprint identification module 10 of the smart door lock 100 collecting the second fingerprint information, the flexible touch screen 30 of the smart door lock 100 displays prompt information for prompting the user to input the second fingerprint information.

In one embodiment, the prompt information includes at least one of numbers, images and texts.

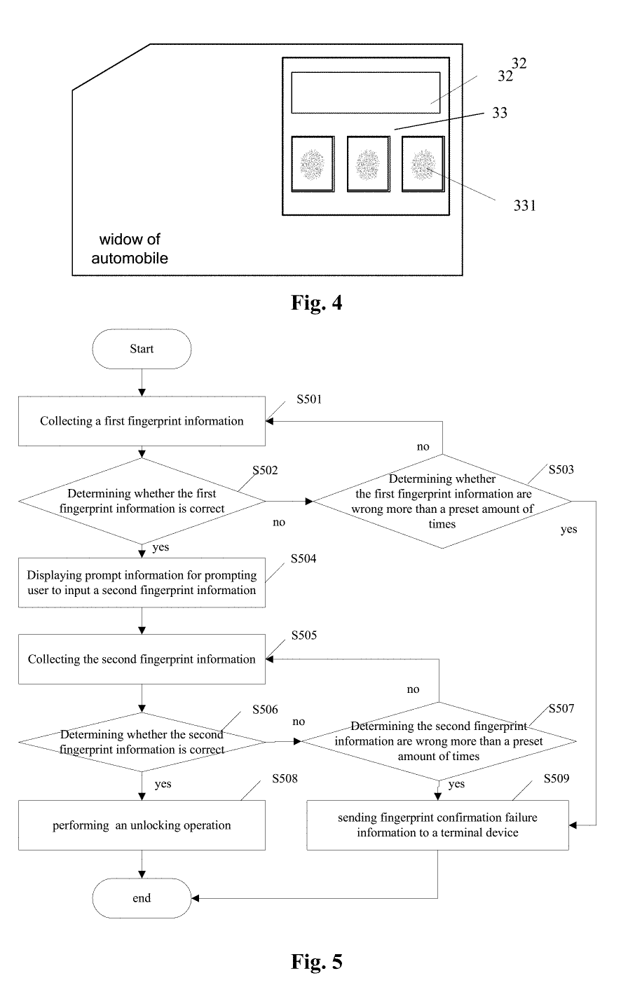

For example, as shown in FIG. 4, in order to facilitate the user to accurately input the second fingerprint information, before the user inputs the second fingerprint information, the prompt information for prompting the user to input the second fingerprint information may be displayed on the display area 32 of the flexible touch screen 30, as, for example, 1) numbers: where one hand is represented by 1 to 5 from the thumb to the little finger in sequence, thus, if numbers randomly displayed on the display area 32 are 1, 3, 4 arranged from left to right, then the user is required to input the fingerprints of the thumb, middle finger and ring finger from left to right in sequence, where a mapping relation between the fingers and the numbers can also be displayed on the display area 32 to prompt the user; 2) images: where the display area displays an image of a hand, where fingerprints to be collected are marked in circle, and the user can input the fingerprints in sequence; 3) texts: where the display area randomly prompts user fingerprints needed to be inputted, such as “middle finger, thumb and ring finger”, and the user can input the fingerprints according to the prompt information on the display area.

In addition, in one embodiment, in order to facilitate the user to input fingerprints, a fingerprint area 33 is displayed at the touch area 31 of the flexible touch screen 30 to prompt the user to input fingerprints at the fingerprint area. The “fingerprint area” as shown in FIG. 4 including three small fingerprint areas 331, together with fingerprint area for collecting the first fingerprint information, is located at the touch area 31 of the flexible touch screen 30. The second fingerprint information is confirmed simultaneously by more than one finger. In one embodiment, the second fingerprint information includes fingerprint information input for three times, and each input fingerprint information can be simultaneously input by a plurality of fingerprints, to increase security; for example, the first input includes inputting middle finger fingerprint; the second input includes simultaneously inputting fingerprints of index finger fingerprint thumb fingerprint and little finger fingerprint; the third input includes simultaneously inputting middle finger fingerprint and ring finger fingerprint. The above three input fingerprint information forms the second fingerprint information. Obviously, in other embodiments, the second fingerprint information may include fingerprint information input for two times, fingerprint information input for four times, and the like.

In one embodiment, when the first fingerprint information or the second fingerprint information are wrong more than a preset amount of times, the communication module 40 of the smart door lock 100 transmits fingerprint verification failure information to the terminal device 200.

The preset amount of times can be, for example, 1, 2, 3, 5, 10 or other values.

In one embodiment, when the first fingerprint information or the second fingerprint information are wrong more than the preset amount of times, the controller 20 of the smart door lock 100 controls the alarm device 50 to raise an alarm.

For example, FIG. 5 also provides another flowchart of method according to an embodiment of the present disclosure in detail, the method includes actions at the following blocks:

At block 501, the fingerprint identification module 10 of the smart door lock 100 collects a first fingerprint information.

At block 502, the controller 20 of the smart door lock 100 determines whether the first fingerprint information is correct.

If yes, the action at block 504 is executed.

If not, the action at block 503 is executed.

At block 503, the controller 20 of the smart door lock 100 determines whether the first fingerprint information is wrong more than a preset amount of times.

If yes, the action at block 509 is executed.

If not, the method returns to the action at block 501.

At block 504, the flexible touch screen 30 of the smart door lock 100 displays prompt information for prompting the user to input a second fingerprint information.

At block 505, the fingerprint identification module 10 of the smart door lock 100 collects second fingerprint information.

At block 506, the controller 20 of the smart door lock 100 determines whether the second fingerprint information is correct.

If yes, the action at block 508 is executed.

If not, the action at block 507 is executed.

At block 507, the controller 20 of the smart door lock 100 determines whether the second fingerprint information is wrong more than a preset amount of times.

If yes, the action at block 509 is executed.

If not, the process returns to the action at block 505.

At block 508, the controller 20 of the smart door lock 100 performs an unlocking operation.

At block 509, the controller 20 of the smart door lock 100 sends fingerprint verification failure information to a terminal device through the communication module 40 of the smart door lock.

It should be noted that specific implementation processes of each action of the method shown in FIG. 5 can be seen in the specific implementation processes described in the above method and will not be described here. The controller 20 determining whether the first fingerprint information being correct, in a specific embodiment, can be: the controller 20 matches the first fingerprint information with a pre-stored fingerprint template, if the first fingerprint information is matched with the pre-stored fingerprint template, the controller 20 determines that the first fingerprint information is correct, otherwise, the controller 20 determines that the first fingerprint information is wrong. The controller 20 determining whether the second fingerprint information is correct, in a specific embodiment, can be: the controller 20 matches the second fingerprint information with a pre-stored fingerprint sequence template, if the second fingerprint information is matched with the pre-stored fingerprint sequence template, the controller 20 determines that the second fingerprint information is correct, otherwise, the controller 20 determines that the second fingerprint information is wrong.

As mentioned above, the above embodiments are only for illustrating the technical solutions of the present disclosure, and are not limited thereto. Although the present disclosure has been described in detail with reference to the above embodiments, it should be understood by those skilled in the field that it can still modify the technical solutions described in the above embodiments or replace some technical features equally. However, these modifications or substitutions do not cause essences of the corresponding technical solutions to depart from the scope of the technical solutions of various embodiments of the present disclosure.

What is claimed is:

1. A smart door lock, comprising:
a fingerprint identification module; and
a controller;
wherein the fingerprint identification module is electrically connected to the controller, the fingerprint identification module is configured to transmit collected fingerprint information to the controller, and the controller is configured to determine whether to perform an unlocking operation according to the fingerprint information.

2. The smart door lock of claim 1, wherein the fingerprint identification module is configured to collect a first fingerprint information and a second fingerprint information, and the controller is configured to perform the unlocking operation when the first fingerprint information and the second fingerprint information are correct.

3. The smart door lock of claim 2, wherein the second fingerprint information comprises information concerning a plurality of fingerprints input sequentially.

4. The smart door lock of claim 3, wherein the second fingerprint information comprises fingerprint information input for a first time and fingerprint information input for a second time, and the fingerprint information input for the second time is different from the fingerprint information input for the first time.

5. The smart door lock of claim 4, wherein the number of fingerprints in the fingerprint information input for the second time is different from the number of fingerprints in the fingerprint information input for the first time.

6. The smart door lock of claim 5, wherein the fingerprints in the fingerprint information input for the second time are not repeated with the fingerprints in the fingerprint information input for the first time.

7. The smart door lock of claim 2, wherein the second fingerprint information is collected later than the first fingerprint information.

8. The smart door lock of claim 1, wherein the fingerprint identification module comprises a flexible touch screen.

9. The smart door lock of claim 8, wherein the smart door lock is a door lock of an automobile, and the flexible touch screen is adhered on a window of the automobile.

10. The smart door lock of claim 8, wherein the flexible touch screen further comprises a display area and the controller is configured to control the display area to display prompt information for prompting users to input fingerprint information.

11. The smart door lock of claim 2, further comprising a communication module; wherein the controller is configured to send fingerprint verification failure information to a preset terminal device through the communication module when the first fingerprint information or the second fingerprint information are wrong more than a preset amount of times.

12. The smart door lock of claim 2, further comprising an alarm device; wherein the controller is configured to control the alarm device to raise an alarm when the first fingerprint information or the second fingerprint information are wrong more than a preset amount of times.

13. A method for controlling a smart door lock, comprising:
collecting fingerprint information by a fingerprint identification module of the smart door lock; and
determining, by a controller of the smart door lock, whether to perform an unlocking operation according to the fingerprint information.

14. The method of claim 13, wherein collecting the fingerprint information by the fingerprint identification module of the smart door lock comprises: collecting a first fingerprint information by the fingerprint identification module of the smart door lock.

15. The method of claim 14, wherein after collecting the first fingerprint information by the fingerprint identification module of the smart door lock, the control method further comprises: determining, by the controller of the smart door lock, whether the first fingerprint information is correct.

16. The method of claim 15, wherein when determining the first fingerprint information is correct by the controller of the smart door lock, the control method further comprises: collecting a second fingerprint information by the fingerprint identification module of the smart door lock.

17. The method of claim 16, wherein the second fingerprint information comprises fingerprint information input for many times.

18. The method of claim 17, further comprising: determining, by the controller of the smart door lock, whether to perform the unlocking operation according to the fingerprint information input each time and an input sequence of the fingerprint information.

19. The method of claim 16, wherein before collecting the second fingerprint information by the fingerprint identification module of the smart door lock, the control method further comprises: displaying prompt information, for prompting the user to input the second fingerprint information, by the flexible touch screen of the smart door lock.

20. The method of claim 16, further comprising:
transmitting fingerprint verification failure information to a terminal device by the communication module of the smart door lock when the first fingerprint information or the second fingerprint information are wrong more than a preset amount of times.
